(19) United States
(12) Patent Application Publication
(10) Pub. No.: US 2009/0146425 A1
(43) Pub. Date: Jun. 11, 2009

(54) SYSTEM AND APPARATUS FOR THE GENERATION OF ELECTICAL POWER

(76) Inventor: Paul Widisky, Apollo Beach, FL (US)

Correspondence Address: LARSON AND LARSON, 11199 69TH STREET NORTH, LARGO, FL, 33773, US

(21) Appl. No.: 11/953,963

(22) Filed: Dec. 11, 2007

(51) Int. Cl. F03D 9/00; F03D 11/04; H02P 9/48; F24F 5/00

(52) U.S. Cl. 290/44; 290/55

(57) ABSTRACT

An application for an electrical power generator includes a set of fan blades coupled to a shaft, the fan blades are in fluid communication with an air conditioner condenser fan whereby the fan blades turn in response to air flow caused by the air conditioner condenser fan. A generator is coupled to the shaft for converting rotational energy of the shaft into electrical energy.

### FIELD OF THE INVENTION

This invention relates to the field of power generation and more particularly to a system for generating electrical power from the wind energy created by an air conditioner condenser.

### BACKGROUND OF THE INVENTION

Air conditioners utilize a fan to cool the coils of the condenser, thereby exchanging heat with the environment. Often, the wind created by the fan is quite substantial, especially in central air conditioning systems, residential and commercial. Currently, this wind energy is lost to the atmosphere. Nowadays, the world is becoming very energy conscious and this loss of energy into the atmosphere is considered a waste, especially considering the millions of commercial and residential air conditioning systems currently deployed.

It is well known how to harness natural wind energy as evidenced by early windmills and present-day wind generator farms. These wind generator farms utilize very large, expensive and heavy generators that would not be practical for the typical home owner or commercial building. Several patents exist for capturing wind or air movement created by un-natural sources and converting the wind energy into electrical or other forms of usable energy. For example, U.S. Pat. No. 5,512,788 to Berenda et al, describes recovering energy from ventilation systems, for example, ventilation from mines, tunnels, etc. This patent does not disclose generating electricity from air movement created by an air conditioner condenser system.

Likewise, U.S. Pat. No. 5,998,882 to Alston describes recovering energy from the exhaust stream of a jet aircraft during takeoff. Again, this patent does not disclose generating electricity from air movement created by an air conditioner condenser system.

Likewise, U.S. Pat. No. 7,200,005 to Gutfield et al, describes recovering energy from the exhaust of a computer server. Again, this patent does not disclose generating electricity from air movement created by an air conditioner condenser system.

Finally, U.S. Pat. No. 6,365,985 to Cohen describes recovering energy from the exhaust of an air conditioner. This patent discloses a wind power generator mounted to an exhaust port of an air conditioner. As shown in FIG. 1 of this patent, a room air conditioner 19 has an exhaust port 18 (the port out of which the cold are is blown) and a generator in proximity to the exhaust port 18. This patent does not disclose generating electricity from air movement created by the cooling fan of an air conditioner condenser system.

What is needed is a system that will extract the excess energy created by the condenser fan.

### SUMMARY OF THE INVENTION

In one embodiment, an electrical power generator is disclosed including a set of fan blades coupled to a shaft, the fan blades are in fluid communication with an air conditioner condenser fan whereby the fan blades turn in response to air flow caused by the air conditioner condenser fan. A generator is coupled to the shaft for converting rotational energy of the shaft into electrical energy.

In another embodiment, a method of generating electrical power is disclosed including situating a plurality of fan blades in proximity to an air conditioning condenser fan such that the fan blades turn in response to receiving at least some of an air movement created when the air conditioner condenser fan turns and interfacing the fan blades with a shaft, the shaft turning in response to the fan blades turning. The shaft connects to a generator for generating electrical power in response to the turning of the shaft.

In another embodiment, an electrical power generator is disclosed including a device for converting wind energy into rotational energy, the means for converting in fluid communication with an air conditioner condenser fan whereby the device for converting the wind energy into the rotational energy converts air flow caused by the air conditioner condenser fan into the rotational energy. The device for converting wind energy into rotational energy is interfaced to a device for converting the rotational energy into electrical energy.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view of a system of the present invention.

FIG. 2 illustrates a side plan view of the present invention.

FIG. 3 illustrates a top plan view of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

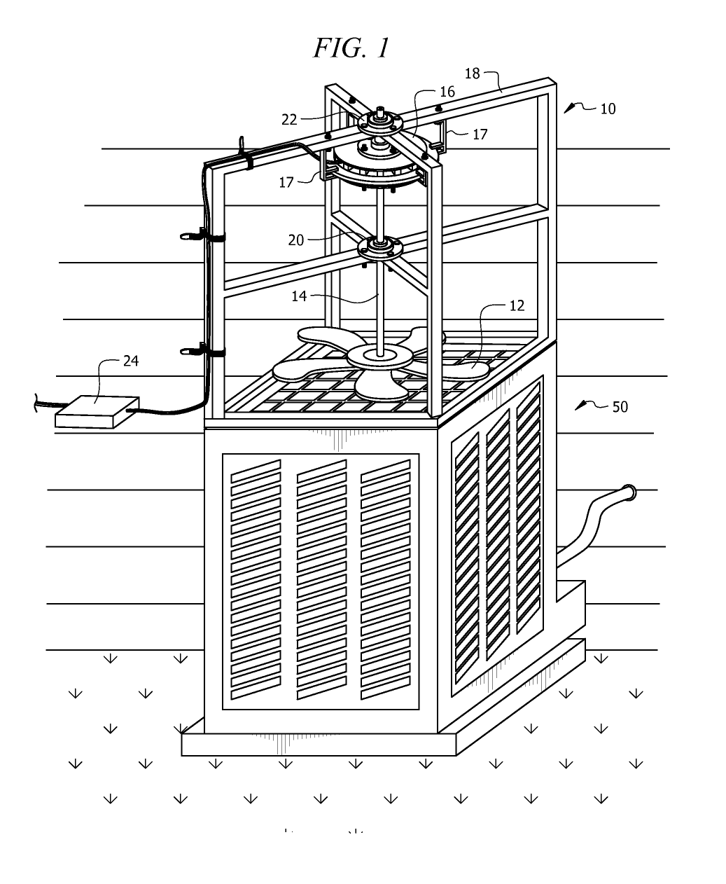

Referring to FIG. 1, a perspective view of a system of the present invention is shown. The air conditioner condenser 50 is an exemplary air condition condenser as known in the industry. Many such units are available and installed in many locations such as on the ground next to a home, on patios, on roofs, etc. Similarly, commercial or industrial air conditioning condensers are also well known and the present invention is not limited to any specific residential or commercial air conditioning condenser variety, make, configuration, orientation, etc. Additionally, the present invention lends itself to being integrated into the air conditioning condenser housing, thereby being an integral part of the air conditioning condenser.

It is well known that air conditioning condensers 50 have an internal fan for moving air across the condenser coils (not visible) in order to condense the hot, gaseous coolant coming from the air conditioner heat exchanger into a cold, liquid coolant for return to the heat exchanger. For residential air conditioning condensers 50, this fan typically blows air upward and out of a grill on the top of the air conditioning condenser 50 at a high rate of speed, creating upward air movement. The present invention capitalizes on this air movement by providing a propeller or fan blades 12 in a direct path of the air movement. The fan blades 12 turn in response to the air movement, in turn rotating a shaft 14 that is interfaced to a generator 16. Although many possible configurations are possible, the embodiment shown includes a frame 18 for holding the fan blades 12, shaft 14 and generator 16. The generator 16 is held to the frame 18 by brackets 17. To reduce friction, the shaft 14 interfaces with the frame 18 with one or more bearings 20/22. The output electrical power from the generator is conditioned for use by a power conditioner 24 as known in the industry. The power conditioner 24 performs such tasks as (but not limited to) storing electrical power, converting the electrical power from DC to AC or from AC to DC, filtering the electrical power, adjusting the frequency and/or phase of the electrical power, etc. The resulting electrical power is then fed to a device that uses such power or fed back into the power grid as known in the industry. In some embodiments, the frame is set atop the air conditioner condenser 50. In some embodiments, the frame is affixed to the air conditioner condenser by ways known in the industry while in other embodiments, the frame is part of the air conditioner condenser 50 and the present invention is integrated into an air conditioner condenser 50.

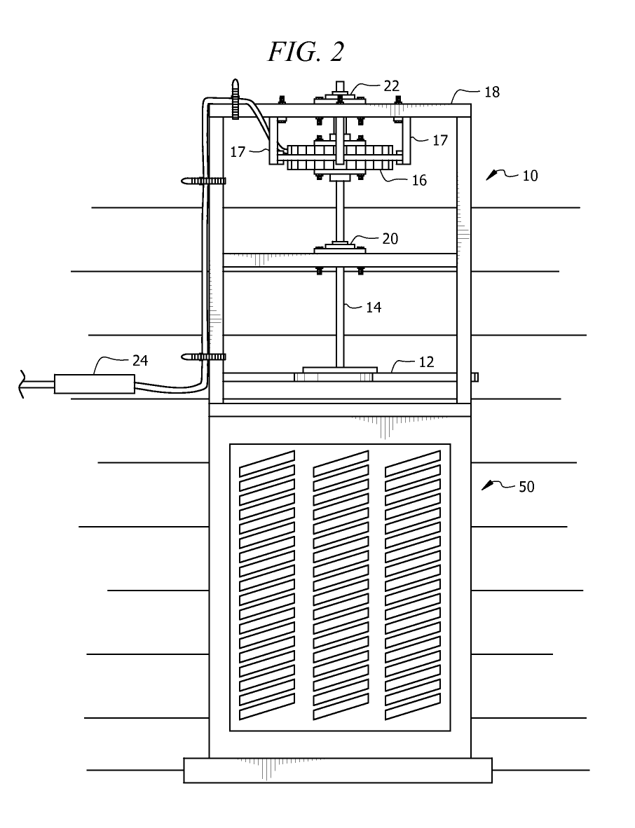

Referring now to FIG. 2, a side plan view of the present invention is shown. The present invention capitalizes on the air movement created by the air conditioning condenser 50 by providing a propeller or fan blades 12 in a direct path of the air movement. The fan blades 12 turn in response to the air movement, in turn rotating a shaft 14 that is interfaced to a generator 16. Although many possible configurations are possible, the embodiment shown includes a frame 18 for holding the fan blades 12, shaft 14 and generator 16. The generator 16 is held to the frame 18 by brackets 17. To reduce friction, the shaft 14 interfaces with the frame 18 with one or more bearings 20/22.

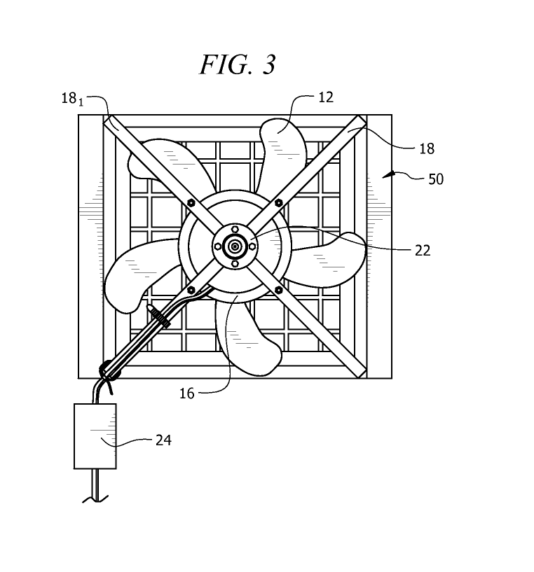

Referring now to FIG. 3, a top plan view of the present invention is shown. The top surface of the fan blades 12 are visible as is the top of the air conditioner compressor 50 and the frame 18. As noted previously, the configuration, the size, style, shape and make up of the frame is anticipated to be any such frame that will position the fan blades 12 at a point where wind energy created by the air conditioner condenser 50 will cause the

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. An electrical power generator comprising:
a set of fan blades coupled to a shaft, the fan blades are in fluid communication with an air conditioner condenser fan whereby the fan blades turn in response to air flow caused by the air conditioner condenser fan; and
a generator coupled to the shaft, the generator converting rotational energy of the shaft into electrical energy.

2. The electrical power generator of claim 1, wherein the set of fan blades, the shaft and the generator are held in a position with relationship to the air conditioner condenser by a frame.

3. The electrical power generator of claim 2, wherein the frame is affixed to the air conditioner condenser.

4. The electrical power generator of claim 1, wherein the set of fan blades, the shaft and the generator are held in a position with relationship to the air conditioner condenser by integrating them into a housing of the air conditioner condenser.

5. The electrical power generator of claim 1, further comprising a power conditioner for accepting the electrical power from the generator and converting the electrical power into useful electrical power.

6. A method of generating electrical power comprising:
situating a plurality of fan blades in proximity to an air conditioning condenser fan such that the fan blades turn in response to receiving at least some of an air movement created when the air conditioner condenser fan turns;
interfacing the fan blades with a shaft, the shaft turning in response to the fan blades turning; and
interfacing the shaft with a generator, the generator generating electrical power in response to the turning of the shaft.

7. The method of generating electrical power of claim 6, wherein the set of fan blades, the shaft and the generator are held in a position with relationship to the air conditioner condenser fan by a frame.

8. The method of generating electrical power of claim 7, wherein the frame is affixed to an air conditioner condenser.

9. The method of generating electrical power of claim 6, wherein the fan blades, the shaft and the generator are held in a position with relationship to the air conditioner condenser fan by integrating them into a housing of an air conditioner condenser.

10. The method of generating electrical power of claim 6, further comprising a power conditioner for accepting the electrical power from the generator and converting the electrical power into useful electrical power.

11. An electrical power generator comprising:
a means for converting wind energy into rotational energy, the means for converting in fluid communication with an air conditioner condenser fan whereby the means for converting the wind energy into the rotational energy converts air flow caused by the air conditioner condenser fan into the rotational energy; and
a means for converting the rotational energy into electrical energy directly interfaced to the means for converting wind energy into rotational energy.

12. The electrical power generator of claim 11, wherein the means for converting wind energy into rotational energy and the means for converting the rotational energy into electrical energy are held in a position with relationship to the air conditioner condenser fan by a frame.

13. The electrical power generator of claim 12, wherein the frame is affixed to an air conditioner condenser.

14. The electrical power generator of claim 11, wherein the means for converting wind energy into rotational energy and the means for converting the rotational energy into electrical energy are integrated into a housing of an air conditioner condenser.

15. The electrical power generator of claim 11, further comprising a means for converting the electrical power into useful electrical power.

16. The electrical power generator of claim 11, wherein the means for converting wind energy into rotational energy is a set of fan blades coupled to a shaft.

17. The electrical power generator of claim 11, wherein the means for converting the rotational energy into electrical energy is coupled to the means for converting wind energy into rotational energy is a set of fan blades coupled by the shaft.
